(19) United States
(12) Patent Application Publication
(10) Pub. No.: US 2015/0114931 A1
(43) Pub. Date: Apr. 30, 2015

(54) VACUUM INTERRUPTER WITH DOUBLE COAXIAL CONTACT ARRANGEMENT AT EACH SIDE

(71) Applicant: ABB TECHNOLOGY AG, Zurich (CH)

(72) Inventors: Dietmar GENTSCH, Ratingen (DE); Tarek LAMARA, Confignon (CH); Alexey SOKOLOV, Baden (CH)

(73) Assignee: ABB TECHNOLOGY AG, Zurich (CH)

(21) Appl. No.: 14/567,489

(22) Filed: Dec. 11, 2014

Related U.S. Application Data
(63) Continuation of application No. PCT/EP2013/001708, filed on Jun. 11, 2013.

(30) Foreign Application Priority Data
Jun. 11, 2012 (EP) 12004395.5
Oct. 18, 2012 (EP) 12007203.8

(51) Int. Cl. H01H 33/66

(52) U.S. Cl. CPC H01H 33/6606; H01H 2203/00; H01H 2201/03
USPC 218/127

(57) ABSTRACT

A vacuum interrupter is provided with a double co-axial contact arrangement in which an inner contact can have a TMF-like or Pin shape arranged within a concentrically cup shaped AMF coil having a single layer or multilayered contact parts at each side, on the side of a fixed contact arrangement as well as on the side of a movable contact arrangement. To provide high conductivity and low resistance, the outer cup shaped contact is made from a double or multiple layer arrangement, wherein at least one layer is made from a hard steel or steel alloy, and at least a second layer is made from material with high thermal conductivity.

### RELATED APPLICATIONS

This application claims priority as a continuation application under 35 U.S.C. §120 to PCT/EP2013/001708, which was filed as an International Application on Jun. 11, 2013, and which claims priority to European Applications 12004395.5 and 12007203.8 filed in Europe on Jun. 11, 2012 and Oct. 18, 2012, respectively. The entire contents of these applications are hereby incorporated by reference in their entireties.

### FIELD

The present disclosure relates to a vacuum interrupter with a double contact arrangement within concentrically arranged contact parts at each side of the arrangement, on the side of a fixed contact arrangement as well as on the side of a movable contact arrangement.

### BACKGROUND INFORMATION

There have been improvements in features of the double-contact vacuum interrupter concept designed to provide high current interruption and a cost effective vacuum interrupter. The most attractive feature of the double-contact assembly is the separate function between the nominal current conducting element, i.e., the inner contacts, and the current interrupting element, i.e., the outer contacts. In this way, each element can be designed independently to its optimum shape and can be made from its best material.

Such a double contact arrangement is known from EP 2 434 513 A1. The inner contacts can be responsible for nominal current conduction and thus should have a very small total resistance (contact and bulk resistances). For this reason, the inner contacts can be TMF-like (TMF: transverse magnetic field) or Butt contacts and be made from high electrical conductive material like copper or CuCr. The inner contacts, according to known techniques, hold the initial phase of the arc before its commutation to the outer contacts.

The outer contacts are only responsible for the axial magnetic field (AMF) field generation, and thus can be designed with a thin cup-shaped layer made from a hard conductive material such as stainless-steel. This option offers many advantages over known AMF contacts leading to lower material cost and very robust contacts assembly. These advantages can be high mechanical strength, lower cost material (stainless-steel instead of copper or CuCr), lower contacts mass-reducing the driving contacts opening forces, and large effective AMF area leading to a larger diffuse vacuum arc distribution.

### SUMMARY

An exemplary embodiment of the present disclosure provides a vacuum interrupter with a double co-axial contacts arrangement. The exemplary vacuum interrupter includes a concentrically cup shaped AMF coil having a single layer or multilayered arranged contact parts at each side as outer contacts, and an inner contact having a TMF-like or pin shape arranged within the concentrically cup shaped AMF coil on the side of a fixed contact arrangement and on the side of a movable contact arrangement. The outer cup shaped contact is made from a single layer, or double or multiple layer arrangement. At least one layer is made from a hard steel or steel alloy, and in case of the double or multilayer arrangement, at least one second layer is made from a material with high thermal conductivity.

### BRIEF DESCRIPTION OF THE DRAWINGS

Additional refinements, advantages and features of the present disclosure are described in more detail below with reference to exemplary embodiments illustrated in the drawings, in which:

FIG. 1 shows the change in total impedance of a vacuum interrupter with Cu—Cr contacts as a function of the contact load;

FIG. 2a shows an exemplary embodiment of the present disclosure in which the inner contacts of both the moving and fixed electrodes are emerging as compared to outer contacts;

FIG. 2b shows an exemplary embodiment of the present disclosure in which only one of the inner contacts (the moving or the fixed inner contact) is emerging compared to the outer contact, while the other inner contact is at the same level as the outer contact;

FIG. 2c shows an exemplary embodiment of the present disclosure in which the inner contact of one electrode (moving and fixed) is rising compared to the outer contact, while the position of the inner part of the opposite electrode is lowered (or pushed inwardly);

FIG. 2d shows an exemplary embodiment of the present disclosure in which all inner and outer contacts are at the same level;

FIG. 2e shows an exemplary embodiment of the present disclosure in which both inner contacts are pushed inwardly compared to the outer contacts, but with a very small distance;

FIG. 2f shows an exemplary embodiment of the present disclosure in which the inner contact of one electrode is pushed inwardly while the other inner contact of the opposite electrode is kept at the same level as the outer contact;

FIG. 3a shows a double layer system with a stainless-steel inner layer and a copper outer layer, according to an exemplary embodiment of the present disclosure;

FIG. 3b shows a double layer system with a copper inner layer and a stainless steel outer layer, according to an exemplary embodiment of the present disclosure;

FIG. 3c shows a multilayer system with stainless steel inner layer, plus a copper outer layer with a thin coverage by steel/nickel layer, according to an exemplary embodiment of the present disclosure; and

FIG. 3d shows a multilayer system with a copper inner layer plus a stainless steel outer layer with a thin coverage by a thin copper layer, according to an exemplary embodiment of the present disclosure.

### DETAILED DESCRIPTION

Exemplary embodiments of the present disclosure enhance the construction of the known techniques discussed above to provide high conductivity and low resistance. Exemplary embodiments of the present disclosure provide a vacuum interrupter with a double co-axial contacts arrangement in which the inner contact can have a TMF-like or pin shape arranged within a concentrically cup shaped AMF coil, with a single layer or multilayered arranged contact parts at each side, on the side of a fixed contact arrangement as well as on the side of a movable contact arrangement.

According to an exemplary embodiment, the outer cup shaped contact is made from a single, double or multiple layer arrangement, wherein at least one layer is made from a hard steel or steel alloy and, in the case of a multilayer arrangement, a second layer is made from a material with high thermal conductivity.

According to an exemplary embodiment, the material of high thermal conductivity is copper.

According to an exemplary embodiment, the hard steel or steel alloy is stainless steel.

According to an exemplary embodiment, the inner layer of the double or multiple layer contact arrangement is made of stainless steel or another material with substantially the same stiffness, and the outer layer is made of copper.

According to an exemplary embodiment, in case of the cup shaped contact arrangement, the inner layer of the contact arrangement is made of copper, and the other or in case of a cup shaped arrangement the outer layer is made of stainless steel.

According to an exemplary embodiment, the contact parts can be positioned such that only the inner contacts can be in contact (i.e., touching) when the vacuum interrupter is in the closed position, and the entire nominal current flows through them.

According to an exemplary embodiment, the gap distance in the opened position of the vacuum interrupter between the inner contacts and the outer contacts is kept the same. In the closed position, the quasi-totality of nominal current flows through the inner contacts.

According to an exemplary embodiment, the gap distance between the outer contacts in the opened position of the vacuum interrupter is smaller than the gap distance between the inner contacts. In the closed position, a big part of the nominal current flows through the inner contacts.

To avoid confusion between the terms “contact” and “electrode,” it is designated that the term electrode refers to the whole moving or fixed parts. An electrode in this case includes the combination of the inner and the outer contacts. The inner and/or outer contacts' relative position can be classified according to the following variations.

There can be many possible contacts elements arrangement with respect to each other in the double-contact system vacuum interrupter. The inner part of the double contact is designed for the nominal current path and thus the contacts resistance should be as low as possible. This is achieved by applying high closing forces to minimize the contact resistance. In general, the contact resistance Rc is inversely proportional to the square of the closing forces, i.e. it decreases by increasing the closing forces.

$${R}_{c} ∝ \frac{1}{\sqrt{{F}_{c}}} \qquad ( 1 )$$

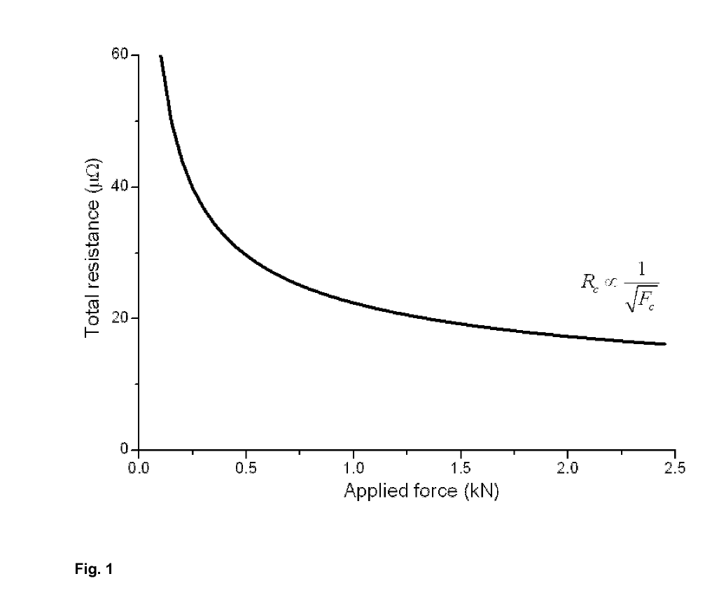

This variation can be illustrated by following FIG. 1, which shows the change in total impedance of a vacuum interrupter (R_{T}=R_{B}+R_{c}) with Cu—Cr contacts as a function of the contact load.

In case of double-contact electrodes, the contact resistance of each contact (inner or outer) can be adjusted by altering the contact forces distribution. This is a functional feature of the present disclosure which concerns to the structural features as described herein.

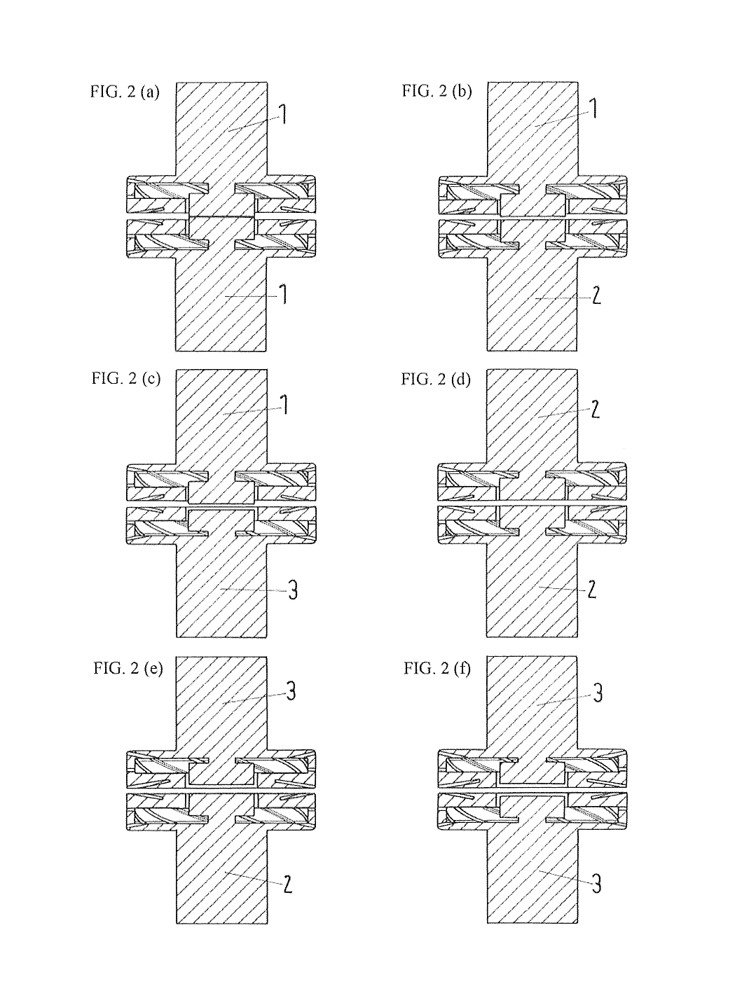

As noted above, in order to avoid confusion between the terms “contact” and “electrode,” the term electrode refers to the whole moving or fixed parts. An electrode in this case includes the combination of the inner and the outer contacts. Firstly, the relative position of the inner and/or outer contacts can be classified according to the following variations, as seen in FIGS. 2a-2f.

The inner contacts 1 can be in contact when the switch is in the closed position and the entire nominal current flows through them. They can also be used at the initial vacuum arcing phase while performing the current interruption. The inner contacts (TMF-like) of both the moving and fixed electrodes can be emerging compared to the outer contacts, as shown in FIG. 2a.

Only one of the inner contacts (the moving or the fixed one) is emerging compared to the outer contact, while the other inner contact (e.g., inner contact 2) is at the same level as the outer contact, as shown in FIG. 2b.

The total forces in the closed position can be held by the inner contacts. This means that the nominal current flows entirely through the inner contacts.

While opening, the arc ignites first between the inner contacts, then develops in succeeding modes as the distance between the contacts increases, and then commutes partially to the outer contacts after some milliseconds. At this time, the outer contacts start to generate an AMF field corresponding to the current flow through them. After that, the arc takes some other milliseconds to commute to a fully diffused arc as the AMF generation starts with some delay (note: the delay caused by the phase shift between the B-field (AMF) and the current due to eddy currents effect is not taken into account here; it's found to be negligible in this double-contact structure).

The gap distance (in the open position) between the inner contacts (moving and fixed) and the outer contacts (moving and fixed) is kept the same. Two relative position cases can be distinguished.

The inner contact of one electrode (moving and fixed) is rising compared to the outer contact, while the position of the inner part of the opposite electrode (e.g., electrode 3) is lowered (or pushed inwardly), as shown in FIG. 2c.

All inner and outer contacts 2 can be at the same level, as shown in FIG. 2d.

The quasi-totality of forces (99%), in the closed position, is held by the inner contacts due to the elastic deformation of the outer contact as described in case 3. This means that the contact resistance through the inner contacts is much lower than the contact resistance through the outer contacts.

The elastic deformation propriety of the outer contacts ensures the arc ignition between the outer contacts as the last touching point is found between them.

These two features give to this configuration an advantageous asset, because it can have the advantage of the low contact resistance for nominal current (between the inner contacts), and the arc ignition between the outer contacts, which can be responsible for the AMF field generation. The arc commutation to the fully diffuse arc takes a shorter time with this arrangement.

In case 3 described above, which is the inverse of the first one, i.e. the gap distance between the outer contacts (in the open position) is smaller than the gap distance between the inner contacts. However, this difference should be as small as 0.1-2.5 mm, for example, 0.5-1.5 mm. Here, we can distinguish two cases.

Both the inner contacts can be pushed inwardly compared to the outer contacts, but with a very small distance, as shown in FIG. 2e.

The inner contact of one electrode is pushed inwardly while the other inner contact of the opposite electrode (e.g., electrode 3) is kept at the same level as the outer contact, as shown in FIG. 2f.

Depending on the difference in the respective gap distances and on the elasticity of the outer contacts coil, the inner contacts can either be touching or not in the closed position. In the case of a big respective gap distance between the inner contacts and/or low outer contacts coil elasticity, the whole forces can be held by the outer contact (case 1), but in case of a small respective gap distance between the inner contacts and/or big outer contacts coil elasticity, a considerable amount of forces can be held by the inner contacts (case 2).

The arc ignition will start at the outer contact, but the contact resistance of the inner contacts (for the nominal current) is increased unless the elastic properties of the outer contacts can be changed (to increase the deformation of the outer contact).

The elasticity of the outer contact can be influenced by the outer contact diameter, the cup thickness and the cup material as well.

According to an exemplary embodiment, the outer contact (cup-shaped) is made from double or multiple layers in which at least one layer is made from a strong, elastic and conductive material like stainless steel, and at least a second layer is made from high thermal conductivity material like copper. This combination offers both robustness and cost effectiveness criteria to the contact assembly and could guarantee a better thermal management during and after arcing (fast contacts cooling).

The multi-layer cup-shaped contact may have several various arrangements on the superposition order of the layers depending on the intended application. For example for a double-layer:

The inner layer is made from stainless-steel (hard conductive material) and the outer one from copper (excellent thermal and electrical conductor). In this case, the major part of the short circuit current passes through outer layer (copper), thus increasing the effective AMF area. This arrangement is favored for increased high current interruption performance.

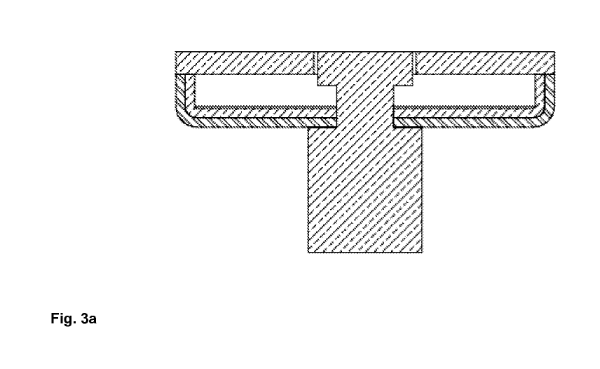

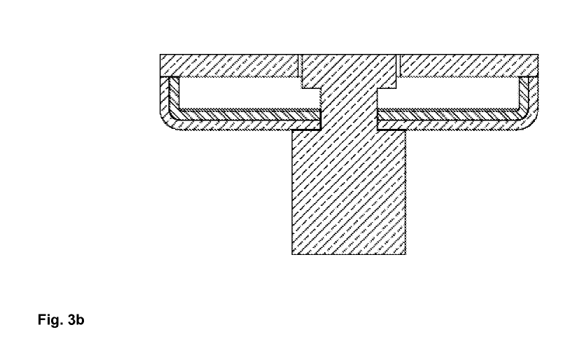

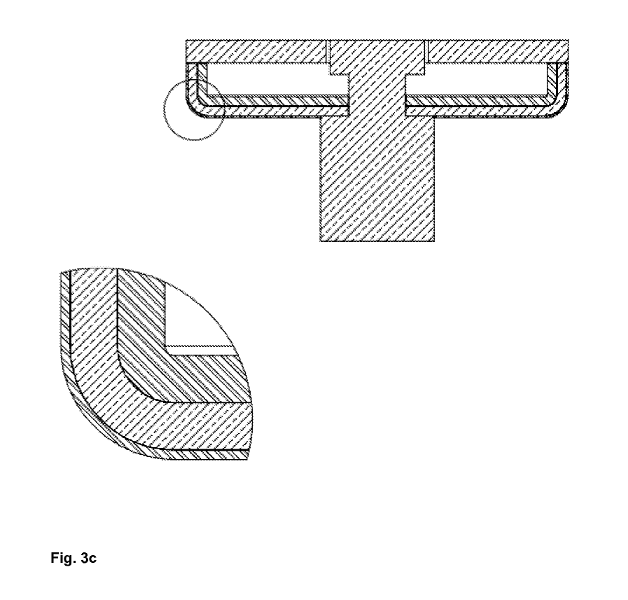

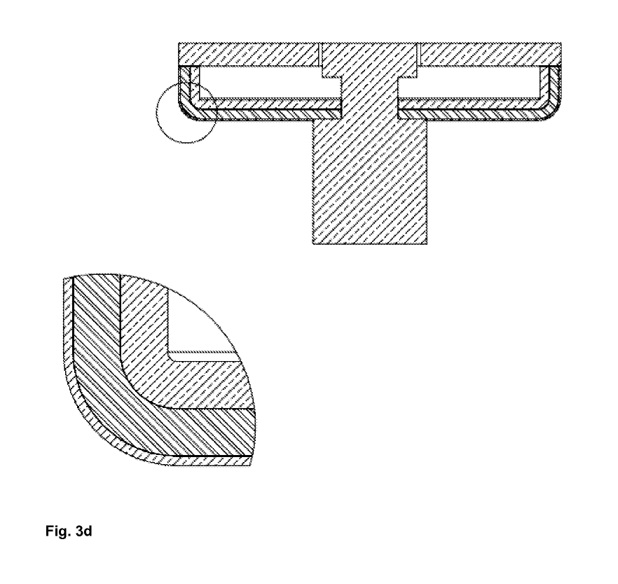

The inner layer is made from copper and the outer one from stainless-steel. Here, the outer layer of the cup-shaped contact is made from stainless-steel and thus could be considered for withstanding high voltage towards the shield. This arrangement can be a good option for high voltage application. The contacts forces distribution changes slightly by using these two arrangements due to the change in the outer contact elasticity as shown, for example, in the exemplary configurations of FIGS. 3a-3d. The force between the outer contacts decreased from 100 N in case of stainless-steel monolayer to ˜70 N by using a double layer.

The inner layer can be made from stainless-steel and a second layer made from copper; a third very thin layer can be superposed to the second outer layer and made from stainless-steel or another metal with good high voltage withstand properties (Nickel, steel-alloy, etc.). This very thin layer can be obtained for example by coating with electroplating, electroforming or PVD processes, etc. With this multilayer structure, the effective AMF area is increased during the high current interruption process, and the high voltage withstand performance of the vacuum interrupter is increased.

An inversed arrangement of the multilayer cup-shape contact is possible. The inner layer is made from copper and the outer layer from stainless-steel (the stainless-steel layer is necessary for contacts robustness). The stainless-steel layer is superposed by a very thin layer of copper which can be obtained by coating with electroplating, electroforming or PVD processes, etc.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A vacuum interrupter with a double co-axial contacts arrangement, comprising:
a concentrically cup shaped AMF coil having a single layer or multilayered arranged contact parts at each side as outer contacts; and
an inner contact having a TMF-like or pin shape arranged within the concentrically cup shaped AMF coil on the side of a fixed contact arrangement and on the side of a movable contact arrangement,
wherein the outer cup shaped contact is made from a single layer, or double or multiple layer arrangement, and
wherein at least one layer is made from a hard steel or steel alloy, and in case of the double or multilayer arrangement, at least one second layer is made from a material with high thermal conductivity.

2. The vacuum interrupter according to claim 1, wherein the material of high thermal conductivity is selected from the group consisting of copper, silver, silver-alloy and copper-alloy.

3. The vacuum interrupter according to claim 1, wherein the hard steel or steel alloy is stainless steel.

4. The vacuum interrupter according to claim 1, wherein an inner layer of the double or multiple layer contact arrangement is made of stainless steel or another material with similar stiffness, and an outer layer or the second layer is made of copper.

5. The vacuum interrupter according to claim 1, wherein, in case of a cup shaped contact arrangement, an inner layer of the contact arrangement is made of copper, and the other or the outer layer is made of stainless steel.

6. The vacuum interrupter according to claim 1, wherein an outer layer of the double or multiple layer contact arrangement is covered or coated with a thin layer up to 100 μm thickness from high voltage withstand material.

7. The vacuum interrupter according to claim 6, wherein the thin layer material is Nickel, steel or steel alloy.

8. The vacuum interrupter according to claim 1, wherein an outer layer of the double or multiple layer contact arrangement is covered or coated with a thin layer up to 100 μm thickness from copper, silver or copper alloy.

9. The vacuum interrupter according to claim 1, wherein the contact parts are positioned such that only a plurality of the inner contacts are in contact when the vacuum interrupter is in a closed position, and the entire nominal current flows through the inner contacts.

10. The vacuum interrupter according to claim 1, wherein a respective gap distance in an open position of the vacuum interrupter between a plurality of the inner contacts, and between the outer contacts is kept the same.

11. The vacuum interrupter according to claim 1, wherein a gap distance between the outer contacts in an opened position of the vacuum interrupter is smaller than a gap distance between a plurality of the inner contacts.

12. The vacuum interrupter according to claim 1, wherein in a closed position of the vacuum interrupter, a totality or a quasi-totality of nominal current flows through a plurality of the inner contacts.

13. The vacuum interrupter according to claim 1, wherein, while opening the contacts of the vacuum interrupter during a current interruption process, an arc ignition takes place between a plurality of the inner contacts, then commutes partially or totally to the outer contacts and transforms to a diffuse arc under the effect of a generated AMF corresponding to current flow through the outer contacts.

14. The vacuum interrupter according to claim 1, wherein, while opening the contacts of the vacuum interrupter during a current interruption process, an arc ignition takes place between the outer contacts, then transforms quickly to a diffuse arc under an effect of the generated AMF corresponding to current flow through the outer contacts.
